(19) United States
(12) Patent Application Publication
(10) Pub. No.: US 2010/0231530 A1
(43) Pub. Date: Sep. 16, 2010

(54) TOUCH PAD FOR MULTIPLE SENSING

(75) Inventors: JAO-CHING LIN, Taipei (TW); LINABEL CHU, Kaohsiung (TW); CHANG-SHENG CHANG, San Jose, CA (US)

Correspondence Address: G. LINK CO., LTD., 3550 BELL ROAD, MINOOKA, IL, 60447, US

(73) Assignee: SENTREND CORPORATION, Kaohsiung (TW)

(21) Appl. No.: 12/403,952

(22) Filed: Mar. 13, 2009

(51) Int. Cl. G06F 3/041

(52) U.S. Cl. 345/173

(57) ABSTRACT

A touch pad for multiple sensing configured to receive touch and pressed-pressure made from at least one finger, conductor or object, comprising an upper conductive layer and a lower conductive layer underneath the upper conductive layer. The upper conductive layer has a plurality of upper sensor members and a plurality of upper joint members. The lower conductive layer has a plurality of lower sensor members and a plurality of lower joint members. The distance-related capacitance on upper sensor members and lower sensor members are detected through the electrically coupled upper joint members and the electrically coupled lower joint members respectively. Besides, an overlapped portion of the upper sensor members and the lower sensor members are electrically conducted by the pressed-pressure. Meanwhile, at least one electrical signal is generated from voltage difference between the upper joint members or between the lower joint members, which the strength of electrical signal is related to the distance of pressed-pressure from the upper joint members or from the lower joint members.

### BACKGROUND OF THE INVENTION

1. Field of the Invention

The present invention is related to a touch pad, particularly to a touch pad having functions of the resistance-sensitive type and the capacitive type touch pad in a simplified structure.

2. Brief Description of the Related Art

With the rapid development of portable interactive electronic products, touch pads have become a common device required in an electronic product. In order to meet the market demand to integrate touch pads in the product designs, not only the quality and performance of touch pads are improved, also the cost is lowered and the yield rate is raised. Touch pads are configured according to various design mechanisms, which can be categorized into four types. These types are resistance-sensitive, the capacitive, the acoustic wave, and the optical touch pads. Each design mechanism gives the touch pad different manufacturing processes, functions, instructions, and applications with individual advantages and disadvantages.

Since a resistance-sensitive touch pad is driven by touch pressure sensing, the contact medium is not limited and the function can be generally enabled by fingers, pencils, access cards or fingers in a glove. In addition, resistance-sensitive touch pads are cost competitive and are mostly used in consumer electronic products such as cell phones, personal digital assistants (PDAs), and global position systems (GPSs). On the other hand, the manufacturing process of capacitive touch pads are more complex and the control circuits chip are more complicated than the resistance-sensitive touch pad, capacitive touch pads are mostly used in the premium electronic devices such as notebook computers and automatic teller machines (ATMs). Sound wave and the optical touch pads are mostly applied in premium electronic products with large dimensions because the technology and manufacturing processes are not ready at a massive production scale.

The structure of a resistance-sensitive touch pad generally comprises a soft conductive plate 14 and a rigid conductive plate 18 hereunder. In addition, a plurality of spacers 16 are disposed between the two plates to prevent electrical contacts between plates when no pressure is applied to the plates. Resistance is measured by either 4-line type wherein both the upper and the lower conductive plates receive signals; or by 5-line type wherein only the upper conductive plate receives signals.

Signals are received at both the upper and the lower conductive plates in the 4-line type. In other words, pairs of electrodes are respectively disposed at the edges of the upper and the lower conductive plates, wherein one pair is symmetrical to X-axis, and the other pair is symmetrical to Y-axis. When a voltage difference is applied to the relative electrodes symmetrical to X-axis at the edges, different potentials are generated at each point on the conductive plate. At the same time, the electrodes symmetrical to Y-axis on the other conductive plate are used for measurement. When the upper and the lower conductive plates are electrically contacted by local pressed-pressure, the potential of a touch point A1 can be measured by the electrodes symmetrical to Y-axis. If the upper and the lower conductive plates are both coated with uniform conductive film, the potential of touch point A1 is linear to the vertical distance between the touch point A1 and the two electrodes at the edges. Components of the touch point A1 on the X-axis and the Y-axis are attained by alternate measuring the potential of the upper and the lower conductive plates.

The means for detecting the position of a touch point used in the 5-line type is identical to the 4-line type, the difference is that an upper conductive film 15 of the 5-line type only has receiving function, electrodes 171, 172, 173, 174 for measuring the X-axis and Y-axis voltage differences are all disposed on the lower conductive film 17, also only a electrode 151 is disposed on the upper conductive film 15 for measurement. As shown in FIG. 3A, when a voltage difference is applied to the electrodes symmetrical to Y-axis 171, 172 (on the physical circuit), a linear potential difference is formed between the electrode 171 and the electrode 172. Following that, the potential of the touch point A1 is detected by the electrode 151 and approximately equals to V*R1/(R1+R2), wherein the resistance R1 and R2 is substantially equal to a surface resistance of a uniform conductive film multiplied by the vertical distance between the touch point and the electrodes 171, 172. Accordingly, the component of the touch point on the X-axis is attained. Similarly, when the circuit implemented is electrically coupled according to the dotted line shown in FIG. 3A, the component of the touch point A1 on the Y-axis can be detected through the upper conductive film 15.

The resistances R1, R2, R3 and R4 are linearly correlated with the vertical distances between the touch point A1 and the electrodes 171, 172, 173, and 174. The resolution of the X and Y axis components depend on the electrically contacted range of the touch point A1, i.e. tip size of the object used for pressing decides the resolution. As a result, a resistance-sensitive touch pad is more suited for pointing operations requiring higher position resolution, such as writing and plotting. Exemplary applications include compact electronic products such as GPS navigation systems, drawing boards or writing boards. However, the operation on a resistance-sensitive touch pad involves pressing and clicking which lead to strain fatigue of the upper and the lower conductive films 15, 17 and the top plate 14. Therefore, a resistance-sensitive touch pad has a limited life and it is not suited for applications used on regular basis or public applications used frequently. The resolution of a resistance-sensitive type touch pad depends on the tip size of object used for pressing. That means, when the tip size of object is thicker (for example: a bigger finger or a blunt object), the position of the touch point can not be precisely measured. Moreover, the distance calculated by a resistance-sensitive touch pad is deviated due to that surface resistance on conductive films is subject to temperature. Resistance-sensitive touch pads are also not recommended to operate in an environment under high temperature or significant temperature changes for the temperature sensitivity of conductive film.

Even though a resistance-sensitive touch pad is advantageous in operations requiring high resolution, the precision on distance measured is largely depending on the quality of the conductive film. A uniform conductive film has a better linearity of surface resistance, which gives more precise calculated distance of the touch point A1. However, when a conductive film has undesirable uniformity, worn out due to repetitive operations, or placed under higher temperature, the distance attained by succeeding calculation of signal processing modules then is deviated. Moreover, the prior art resistance-sensitive touch pad is not configured to receive pressing signals from multi-contact points. There are many limitations existed in the application of prior art resistance-sensitive touch pads.

Therefore, capacitive touch pads which compensate the limitations of the resistance-sensitive touch pad share a substantial part of the touch pads market. Similar to a resistance-sensitive touch pad, a capacitive touch pad also detects components on X-axis and Y-axis respectively, yet the operation mechanisms and applied devices vary. The general structure of a dual axes capacitive touch pad is shown in FIG. 3B, the operation method starting by making a touch on the surface of a cover plate 10 by a finger or an electrically conductive object. A first sensor layer 11 with a plurality of first axial traces 11a, 11b is disposed under the cover plate 10. When the finger or the conductive objects are positioned on the cover plate, capacitance on the plurality of first axial traces for different horizontal distances is also different. If the plurality of first axial traces is sorted by arrays symmetrical to an X-axis or a Y-axis, the components on Y-axis or the X-axis are attained by calculation on corresponding capacitance of each trace. Similarly, the components of the contact point A1 on X-axis or the Y-axis are attained by further installing an insulating layer 12 and a second sensor layer 13 with a plurality of second axial traces 13a under the first sensor layer 11, then sorting the second axial traces 13a symmetrical to Y-axis or an X-axis.

A capacitive touch pad senses capacitance changes upon a finger or an electrically conductive object approaching the touch pad, instead of local pressed-pressure. The life of a capacitive touch pad is longer because the film electrodes or the touch cover plate of the touch pad do not have the limitations such as generating damages or elastic fatigue due to by repetitive pressing operations. Capacitive touch pads are more suited in applications on regular operation basis or in public than resistance-sensitive touch pads.

In addition, conductive films used by prior art resistance-sensitive touch pads for receiving signals on only a single point contact at one time, and suited for single point contact operation. On the contrary, capacitive touch pads have a plurality of independently wired first axial traces and second axial traces, and capable of sensing signals generated by multi-points contacts. Accordingly, the functions delivered by touch pads are diversified, for example a multi-finger-touch mechanism triggered by different gestures is utilized in the latest iPhone mobile design adding more functions to a mobile phone with simplified operation procedure.

A capacitive touch pad is not easily affected by surrounding temperature and using time, the capacitive touch pad comparing to that a resistance-sensitive touch pad. However it is easily affected by interference of surrounding electromagnetic waves, human physical condition (fingers), and ambient humidity. Therefore the capacitive touch pad is not suited for applications under conditions such as high humidity, contacting with fingers in gloves or wet fingers, as well as configured, equipped or used in devices generating electromagnetic waves, specifically electromagnetic wave with frequency in the capacitance sensing range of the touch pad.

Because resistance-sensitive and the capacitive touch pads are characterized by own advantages and disadvantages, application fields and market niche are different. However, the resistance-sensitive touch pad and the capacitive touch pad alone no longer meet the market demands as designs of portable devices are getting smaller and with extra adding functions. For example, resistance-sensitive touch pads are only applicable to single point touch in the prior art and not applicable to multi-finger touch gesture. In addition, resistance-sensitive touch pads are only suited for private application used infrequently, devices usually have short life, also coordinates offset with temperature. Capacitive touch pads deliver multi-finger gesture sensing, but do not have sharp sensing resolution as resistance-sensitive touch pads operated by a pencil-shaped object. Also, capacitive touch pads are easily affected by human body condition, ambient humidity, and surrounding electromagnetic wave intensity.

Therefore a new type of plate with a capacitive touch pad A stacking on a resistance-sensitive touch pad B is disclosed in the patent of Taiwan Utility Model Patent No. M321553. As shown in FIG. 1, the first touch pad A disclosed in the patent is formed by sequential stack of a cover plate 10, a first sensor layer 11, a insulating layer 12, a second sensor layer 13 and a top plate 14, and has the function of the prior art capacitive touch pad. The second touch pad B disclosed in the patent is formed by sequential stack of a top plate 14, a upper conductive film 15, a spacers layer 16, a lower conductive film 17 and a substrate 18, and has the function of the prior art resistance-sensitive touch pad. Though the previously described patent integrating the prior art resistance-sensitive type and the capacitive type into one single touch pad structure. Essentially, the patent is only characterized by physically stacking one prior art capacitive touch pad onto one prior art resistance-sensitive touch pad. The embodiment according to the patent only saves a top plate which is a layer of insulator shared by a capacitive and a resistance-sensitive touch pad. Though the embodiment provides both functions of a capacitive and a resistance-sensitive touch pad concurrently or alternately, the resulting thickness and weight of the new type touch pad is doubled. Consequently, the multi-function touch pads become too bulky and heavy to use in portable devices.

Moreover, the stacking structure of a capacitive type pad on a resistance-sensitive type pad generates light transmittance which is far below expected light transmittance. For example, stacking a capacitive touch pad with 95% light transmittance on a resistance-sensitive touch pad with 85% of light transmittance, the resulted light transmittance of the stacked pads is reduced to 80%. The resulted light transmittance is much lower than light transmittance of devices available on the shelf and is uncompetitive in the market.

By using the stacked plate with a capacitive touch pad on top and a resistance-sensitive touch pad beneath, the sensing capability of the resistance-sensitive type is reduced greatly. The resistance-sensitive touch pad determines the position of the touch point A1 according to the voltage generated upon an upper conductive film contacting a lower conductive film. When there are more layers covered on the upper conductive film, for example: the thickness of the insulating layer 12 plus the cover plate 10 exceeds 1 mm, adding on the thickness of the top plate 14, the pressure required to enable an electrical contact by pressing actions is high. Consequently, the sensitivity and responding speed of the resistance-sensitive touch pad are affected. When users perform writing and plotting function with the resistance-sensitive touch pad operation, operation may become slow, crashed, or intermittent.

There are challenges in manufacturing process and cost control of the production for such touch pad stacking a capacitive type pad and a resistance-sensitive pad. Firstly, by stacking pads of two types, the overall manufacturing process and the cost are not saved. The manufacturing processes and costs are totally the same. In fact, the process demands extra steps to stack two touch pads. Secondly, cables wiring used in the capacitive and the resistance-sensitive touch pad are independent from each other, and not affected by the pads stacking. As a matter of fact, the cable quantity and thickness of the stacked pads are doubled. Thirdly, there is one transmitting cable added which requires rewiring to connect the cable to the succeeding signal processing modules and requires extra cost due the assembly process and wiring work of the cable added.

Therefore, the primary goal of the present invention is to provide a touch pad for multiple sensing having the advantages of a resistance-sensitive and a capacitive touch pad without adding extra layers, thickness as well as the number of cables, without sacrificing the sensitivity, and minimized the negative impact on the light transmittance.

### SUMMARY OF THE INVENTION

In order to overcome the limitations of the prior art, an object of the present invention is to provide a touch pad for multiple sensing having the advantages of a capacitive and a resistance-sensitive touch pad at the same time with a two-layer structure. The touch pad for multiple sensing comprises an upper conductive layer and a lower conductive layer. The upper conductive layer has a plurality of upper sensor members and a plurality of electrically coupled upper joint members. The plurality of upper sensor members are disposed on middle of one surface of the upper conductive layer and the plurality of upper joint members are disposed on border of one surface of the upper conductive layer. The lower conductive layer has a plurality of lower sensor members and a plurality of electrically coupled lower joint members. The plurality of lower sensor members are disposed on middle of one surface of the lower conductive layer and the plurality of lower joint members are disposed on border of one surface of the lower conductive layer. In addition, the lower sensor members are disposed against the upper sensor members in a certain distance.

The distance-related capacitance on upper sensor members and lower sensor members for the approaching fingers or conductors can be detected through the upper joint members and lower joint members respectively. An overlapped portion of the upper sensor members and lower sensor members are electrically conducted by pressed-pressure, and at least one electrical signal can be generated from voltage difference between the upper joint members or between the lower joint members, which the strength of electrical signal is related to the distance of pressed-pressure from the upper joint members or lower joint members.

Another objective of the present invention is to provide a touch pad for multiple sensing having the advantages of a capacitive and a resistance-sensitive touch pad at the same time. The touch pad for multiple sensing comprises an upper conductive layer, a conducting layer and a lower conductive layer. The upper conductive layer has a plurality of upper sensor members and a plurality of electrically coupled upper joint members. The upper sensor members are disposed on middle of one surface of the upper conductive layer and a plurality of upper joint members are disposed on border of one surface of the upper conductive layer. The conducting layer has a plurality of conducting bridges which each of said conducting bridges has a span between any two of the upper sensor members to enable the two of the sensor members being electrically conducted. The lower conductive layer has a conducting film disposed on middle of one surface of the lower conductive layer and a plurality of electrically coupled lower joint members disposed on border of one surface of the lower conductive layer. The conducting film of the lower conductive layer is disposed against the upper sensor members and the conducting bridges in a certain distance.

The distance-related capacitance on upper sensor members for the approaching fingers or conductors can be detected through the electrically coupled upper joint members. An overlapped portion of the upper sensor members and conducting bridges and the conducting film are electrically conducted by pressed-pressure, and at least one electrical signal are generated from voltage difference between the upper joint members or between the lower joint members, which the strength of electrical signal is related to the distance of pressed-pressure from the upper joint members or lower joint members.

In order to make the aforementioned objects, features and advantages of the present utility model invention will be more readily comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a multi-layer structure according to a prior art patent;

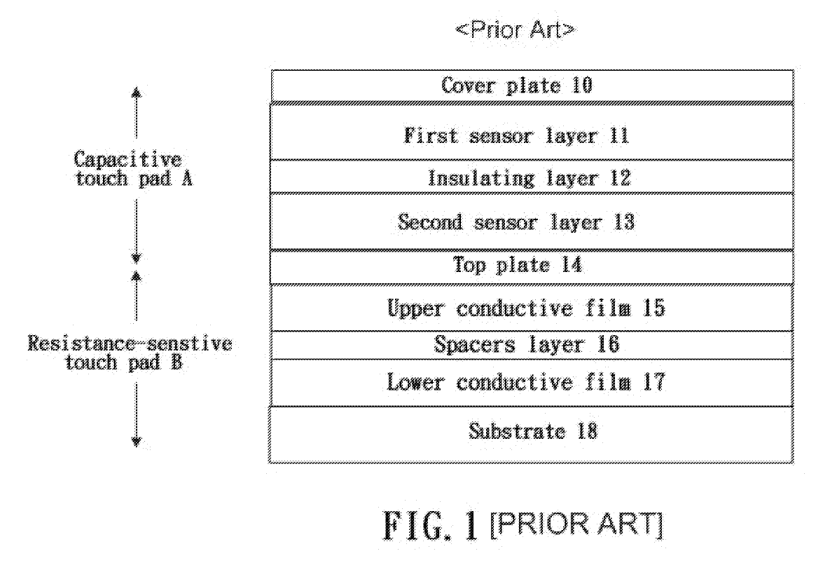

FIG. 2A shows a two-layer structure of a first embodiment of the present invention;

FIG. 2B shows a three-layer structure of a second embodiment of the present invention;

FIG. 3A shows the operation mechanism of a resistance-sensitive touch pad according to the prior art patent;

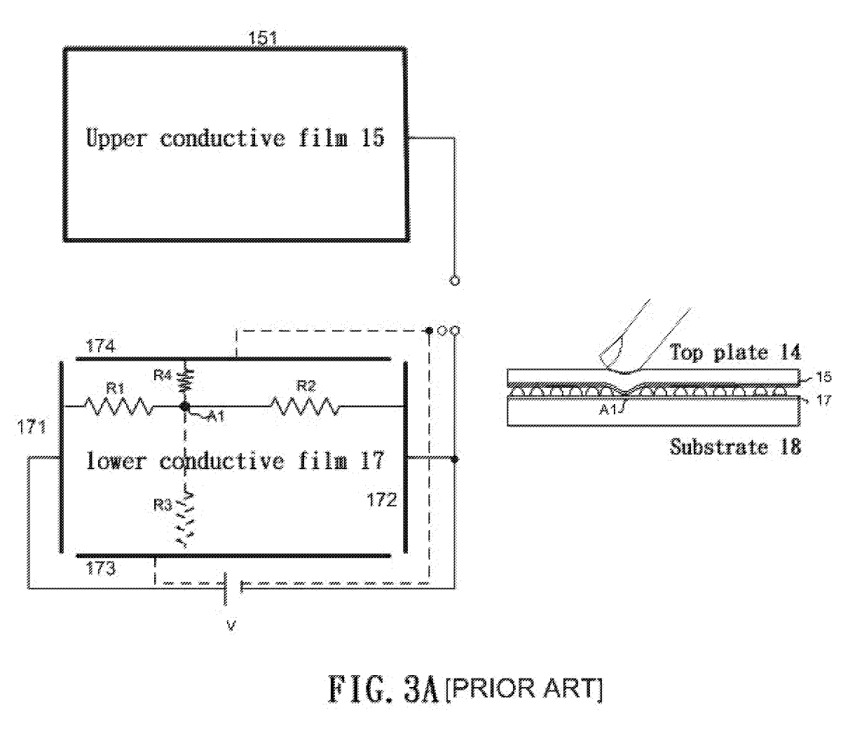

FIG. 3B shows the operation mechanism of a capacitive touch pad according to the prior art patent;

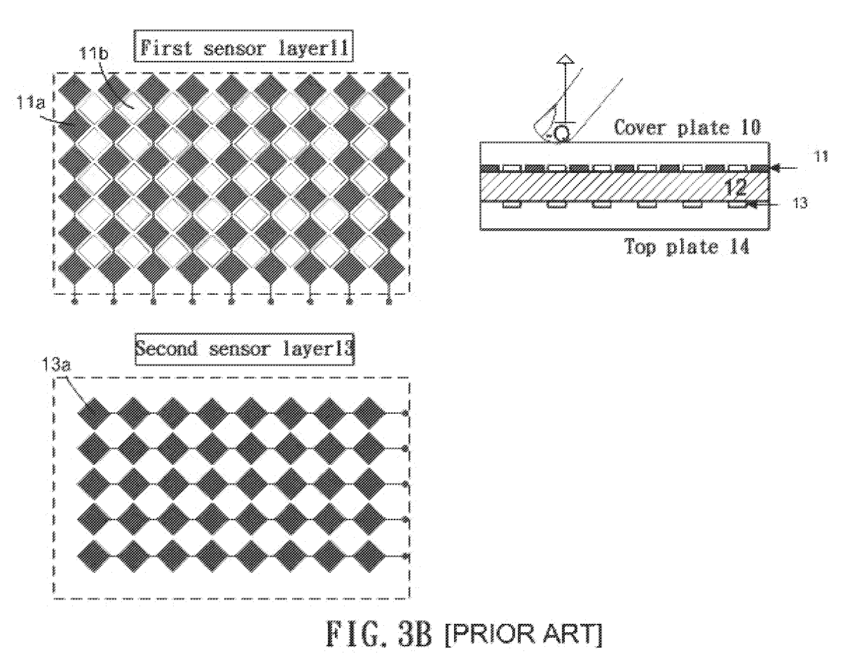

FIG. 4A shows the operation mechanism of attaining an X component with resistance responding signals in the first embodiment of the present invention;

FIG. 4B shows the operation mechanism of attaining a Y component with resistance responding signals in the first embodiment of the present invention;

FIG. 4C shows the operation mechanism of attaining the X and the Y components with capacitance responding signals in the first embodiment of the present invention;

FIG. 5A shows the operation mechanism of attaining the X component with resistance responding signals in the second embodiment of the present invention;

FIG. 5B shows the operation mechanism of attaining the Y component with resistance responding signals in the second embodiment of the present invention; and

FIG. 5C shows the operation mechanism of attaining the X and the Y components with capacitance responding signals in the second embodiment of the present invention.

### DETAILED DESCRIPTION OF THE INVENTION

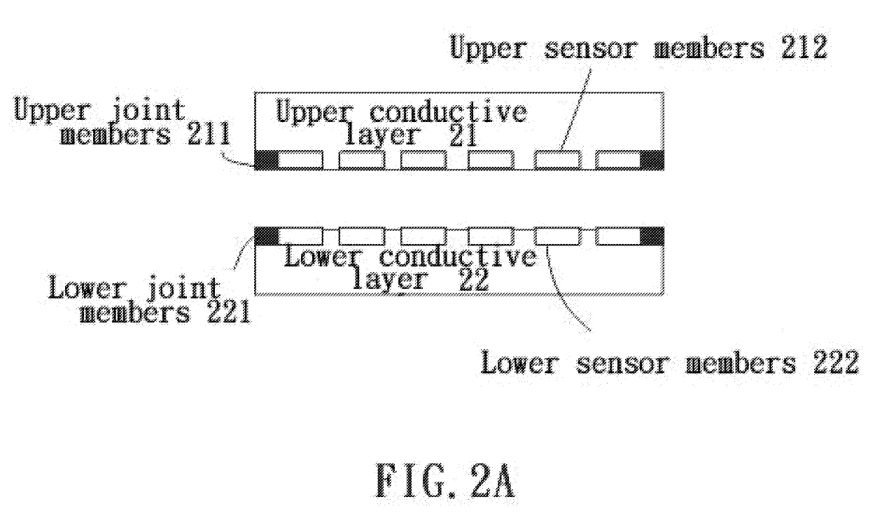

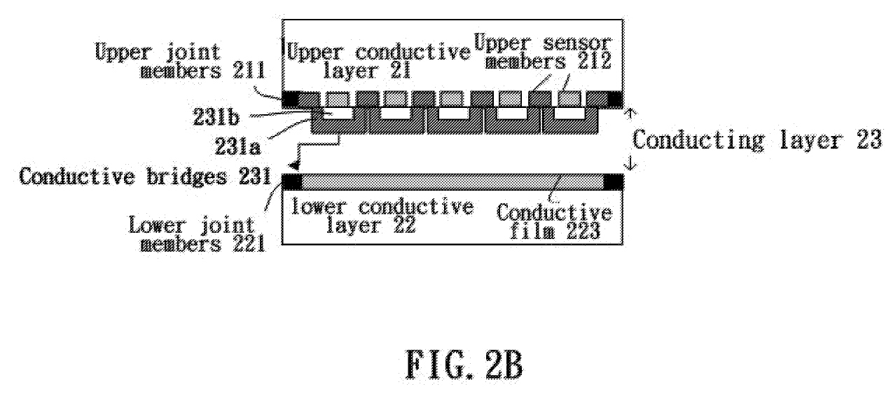

The first embodiment of the present invention is shown in FIG. 2A. The embodiment comprises: an upper conductive layer 21 and a lower conductive layer 22. The surface of the upper conductive layer 21 includes a plurality of upper sensor members 212 disposed in the middle and a plurality of upper joint members 211 disposed on the edge. The surface of the lower conductive layer 22 also includes a plurality of lower sensor members 222 disposed in the middle and a plurality of lower joint members 221 disposed on the edge. The upper conductive layer 21 is disposed relative to the lower conductive layer 22 by a distance, such that the surfaces of the upper sensor members 212 and the lower sensor members 222 are disposed opposite each other. The distance is relative to the areas, thicknesses and material structures of the upper sensor members and the lower sensor members, as well as dielectric of the space between the upper conductive layer and the lower conductive layer.

The upper conductive layer 21 further comprises a flexible insulating sheet 214, which is disposed on the plurality of upper sensor members 212 to be contacted by fingers or conductive objects to allow local deformation generated by pressing. Following that the upper sensor members 212 and the lower sensor members 222 contact each other and generate electrical conduction.

The lower conductive layer 22 further comprises a substrate 224 disposed under the plurality of lower sensor members 222, for supporting the lower conductive layer when it is touched.

A plurality of spacers having three dimensional structure are disposed in the space between the upper conductive layer 21 and the lower conductive layer 22 for isolating the plurality of upper sensor members from the plurality of lower sensor members when the touch pad is not contacted or pressed. The spacers can be micro particles placing between the upper conductive layer and the lower conductive layer with various three dimensional structures, for example: a sphere, a column, a roller, a honeycomb, a spring or a micro three dimensional structure. The size of the micro particles is related to structure, elasticity, and touch scenarios configured of the touch pad as well as the capacitance strength of the lower sensor members 222.

The micro particles are movable in the space and separated from each other under the pressure of touches to allow the vertically overlapped portions of the upper sensor members 212 and the lower sensor members 222 being electrically conducted. The micro particles can also be dispersedly fixed in the space, such that the fixed portions of the upper sensor members 212 and the lower sensor members 222 are electrically conducted by touches. Alternatively, a portion of the micro particles can be fixed while the other portions of the micro particles are movable in the space to provide diversified touch functions.

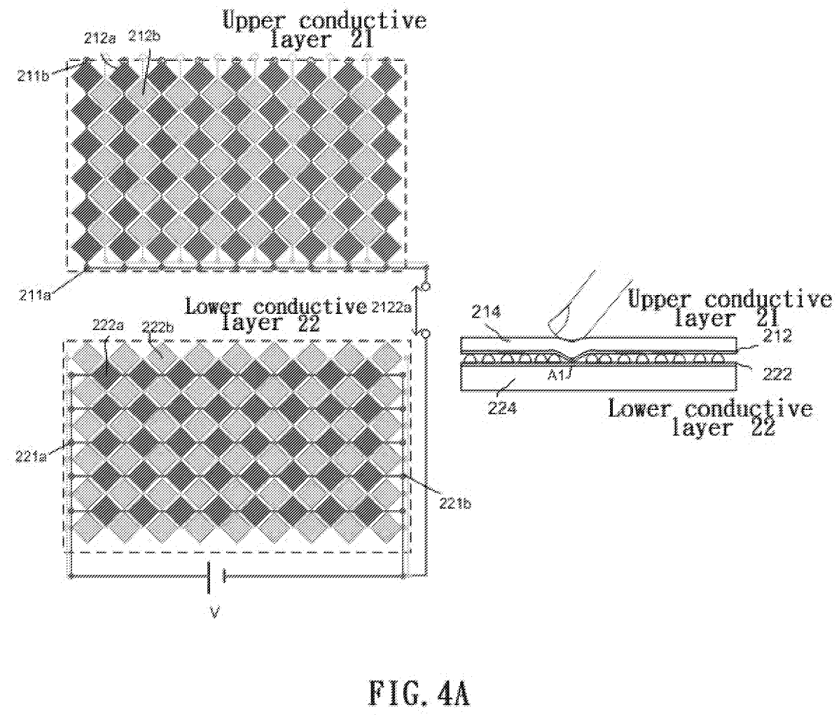

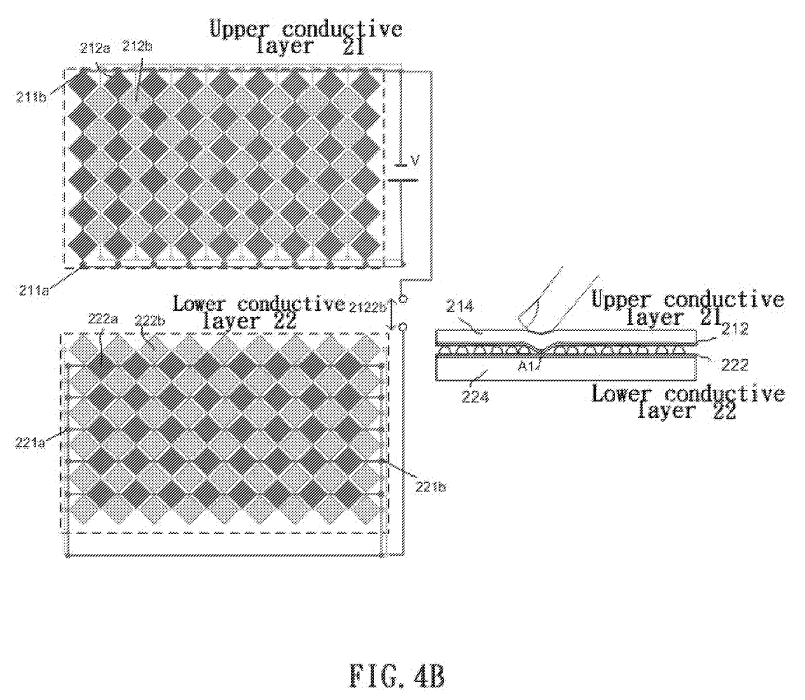

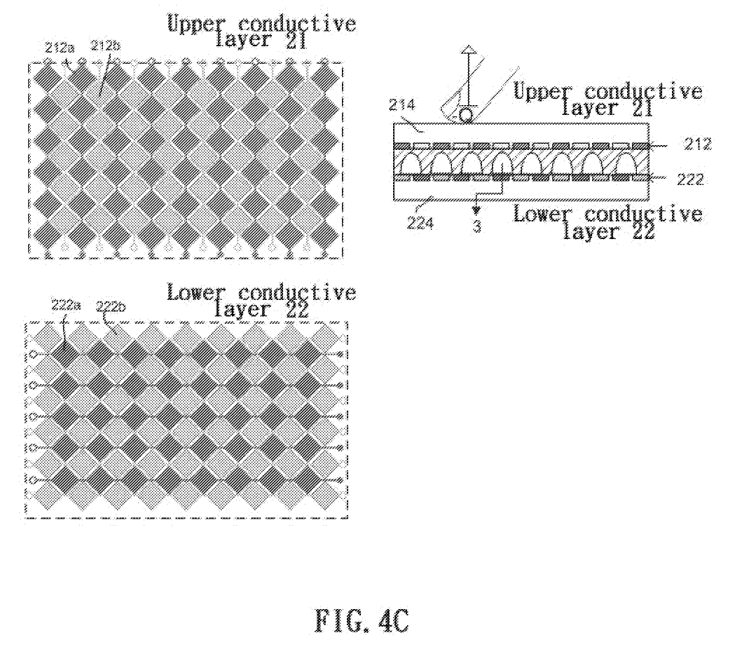

In the first embodiment of the present invention, the sorting order between the upper sensor members 212 and the upper joint members 211 as well as the lower sensor members 222 and the lower joint members 221 is as shown in FIG. 4A. The upper sensor members are two arrays 212a, 212b symmetrical to Y-axis alternately sorted. One end of a member is electrically coupled to the upper joint members 211a disposed on the edge of a lower side while the other end of the member is electrically coupled to the upper joint members 211b on the edge of an upper side. The lower sensor members are two arrays 222a, 222b symmetrical to X-axis alternately sorted. One end of a member is electrically coupled to the upper joint members 221a disposed on the edge of a left side while the other end is electrically coupled to the upper joint members 221b on the edge of a right side.

When resistance responding signals are generated, a voltage V is applied on the left side lower joint members 221a and the right side lower joint members 221b (as shown in FIG. 4A). In case that the upper conductive layer recesses by pressing, the upper sensor members 212a, 212b around the touch point A1 are electrically conducted to the lower sensor members 222a, 222b, therefore by measuring a voltage 2122a between the upper joint members 211a, 211b and the right lower joint members 211b, an X component of the touch point A1 is calculated according to the relation between the resistances of the upper sensor members as well as the lower sensor members and the distance. The Y component of the touch point A1 is attained by applying a voltage V on the lower side upper joint members 211a and the upper side upper joint members 211b (as shown in FIG. 4B). In case that the upper conductive layer recesses by pressing, the upper sensor members 212a, 212b around the touch point A1 are electrically conducted to the lower sensor members 222a, 222b, then the voltage 2122b between the lower joint members 221a, 221b and the upper side upper joint members 211b is measured.

When the upper sensor members act as receivers in the resistance-sensitive type, both of the upper side upper joint members 211b and the lower side upper joint members 211a are connected at the same time for voltage measurement, or only one side of the upper joint members is connected for voltage measurement. Similarly, when the lower sensor members act as the receiver in the resistance-sensitive type, both of the left side lower joint members 221a and the right side lower joint members 221b can be connected at the same time for voltage measurement, or only one side of the lower joint members are connected for voltage measurement.

When capacitance responding signals are generated, portions 212a of the upper sensor members sorted at intervals are connected to measure capacitance signals while the other portions of the upper sensor members 212b are not electrically coupled. The measurement results are data used for attaining X component. Similarly, portions 222a of the lower sensor members sorted at intervals are connected to measure the capacitance signals while the other portions of the lower sensor members 222b are not electrically coupled. The measurement results are used for attaining the Y component. The sorting axis applied to the upper sensor members and the lower sensor members are not limited to X-axially symmetrical or Y-axially symmetrical. It can be alternately between two axes, or any two unparallel axes.

A second embodiment of the present invention is as shown in FIG. 2B, which comprises an upper conductive layer 21, a conducting layer 23 and a lower conductive layer 22. The surface of the upper conductive layer 21 includes a plurality of upper sensor members 21 in the middle and a plurality of upper joint members 211 on the edge. The surface of the conducting layer 23 includes a plurality of conductive bridges 231 in the middle, and the conductive bridges are disposed on the surface between any two of the upper sensor members 212 to enable the electrical conduction between any two of the upper sensor members 212. The surface of the lower conductive layer 22 has a conductive film 223 and a plurality of lower joint members 221. The upper conductive members 21 are disposed relative to the lower conductive members 22 at a distance, such that the surfaces of the upper sensor members 212 and the lower sensor members 222 and the conductive bridges 231 are disposed oppositely. The distance is relative to the areas, thicknesses and material structures of the upper sensor members 212 and the lower sensor members 222, as well as the dielectric of the space between the upper conductive layer and the lower conductive layer.

The upper conductive layer 21 further comprises a flexible insulating sheet 214 disposed on top of the plurality of upper sensor members 212 to be contacted by fingers or conductive objects to allow local deformation generated by pressing. Following that the upper sensor members 212 and the lower sensor members 222 contact each other to generate electrical conduction.

The lower conductive layer 22 further comprises: a substrate 224 disposed under the conductive film 223, for supporting the lower conductive layer 22 when the pad is pressed.

A plurality of spacers 3 with three dimensional structures are disposed in space between the upper conductive layer 21 and the lower conductive layer 22 to isolate the plurality of upper sensor members from the plurality of lower sensor members when the pad is not pressed. The spacers can be micro particles placing between the upper conductive layer and the lower conductive layer with various three dimensional structures, for example: a sphere, a column, a roller, a honeycomb, a spring or a micro three dimensional structure. The size of the micro particles is related to structure, elasticity, and touch scenarios configured of the touch pad as well as the capacitance strength.

The micro particles are movable in the space and separated from each other under the pressure of touches to allow the vertically overlapped portions of the upper sensor members 212 and the conductive film 223 being electrically conducted. The micro particles can also be dispersedly fixed in the space, such that the fixed portions of the upper sensor members 212 and the conductive film 223 are electrically conducted by pressed-pressure. Alternatively, a portion of the micro particles can be fixed while the other portions of the micro particles are movable in the space to provide diversified touch functions.

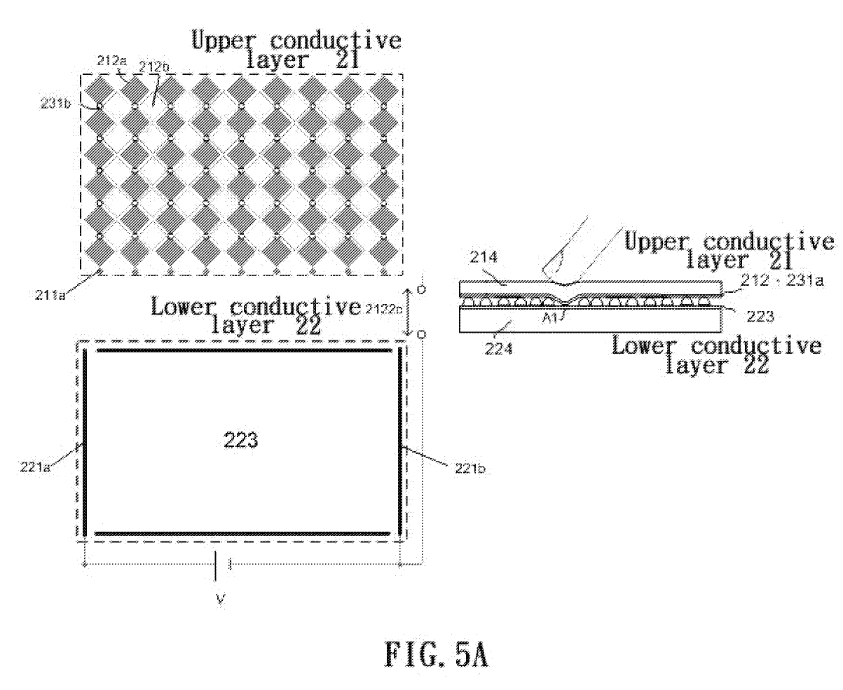

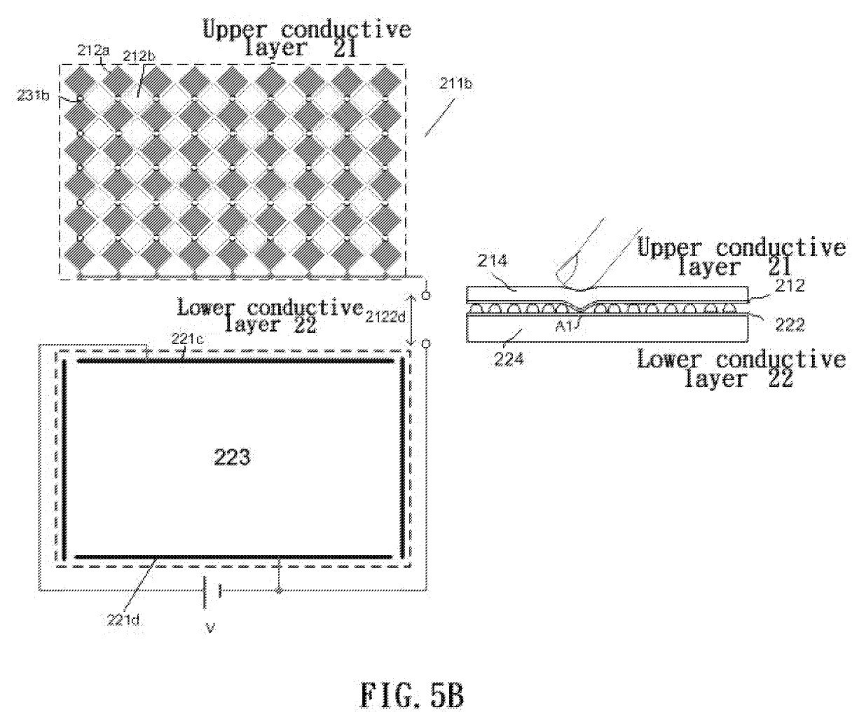

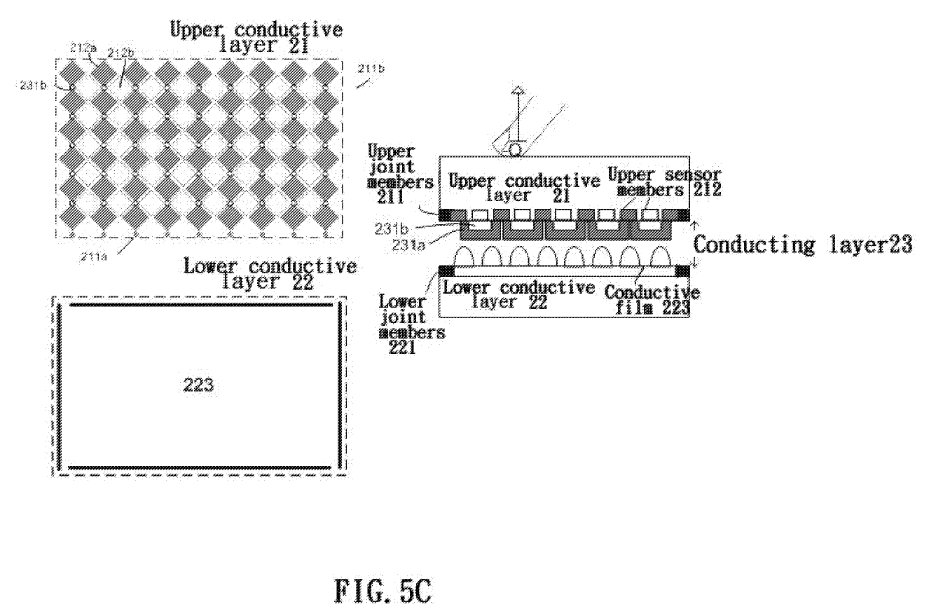

In the second embodiment of the present invention, the sorting order of the upper sensor members 212, the upper joint members 211, the conductive bridges 231, the conductive film 223 and the lower joint members 221 is as shown in FIG. 5A. The upper sensor members are composed of an array 212a symmetrical to Y-axis and a plurality of dot arrays 212b disposed in the spaces along the array 212a symmetrical to Y-axis. One end of the array 212a symmetrical to Y-axis is electrically coupled to the upper joint members 211a disposed on the edge of the lower side. The conductive bridges 231 are disposed between the two X-axially adjacent dot arrays 212b. The conductive bridges 231 have insulating pad 231b and C-type conductive path 231a disposed across the two sides of the insulating pads 231b. The coverage of the insulating pad 231b covers the interlaced area of the Y-axially symmetrical array 212a and the C-type conductive path 231a to isolate an electrical connection between the array 212a symmetrical to Y-axis and the C-type conductive path 231a. The length of the C-type conductive path is cross the gap of the two X-axially adjacent dot arrays 212b, such that the two dot arrays are electrically conducted via the C-type conductive path 231a. The conductive bridges 231 are disposed along the X-axis, such that several arrays symmetrical to X-axis are formed by the dot arrays 212b. Meanwhile, the arrays symmetrical to X-axis have extended members at the end electrically coupled to the upper joint members 211b of the right side edge.

The conductive film is also electrically coupled to the lower joint members 221 on the edges around the surface. When the resistance responding signals are generated, a voltage V is applied between the left side of the lower joint members 221a and the right side of the lower joint members 221b (as shown in FIG. 5A). In case that the upper conductive layer recesses by pressing, the upper sensor members 212a, 212b around the touch point A1 and the conductive bridges 231 are electrically conducted to the conductive film 223. The X component of the touch point A1 is calculated according to the relation between the resistances of the upper sensor members as well as the conductive film and the distance and the measuring results of the voltage 2122c between the upper joint members 211a, 211b and the right side lower joint members 211b. The Y component of the touch point A1 is attained by firstly applying a voltage V to the upper side lower joint members 211c and the lower side lower joint members 211d (as shown in FIG. 5B). In case that the upper conductive layer recesses by pressing, the upper sensor members 212a, 212b around the touch point A1 and the conductive bridges 231 are electrically conducted to the conductive film 223. Following that the voltage 2122d between the lower joint members 221a, 221b and the lower side lower joint members 211d is measured.

The upper sensor members 212a, 212b are not only connected to the upper joint members 211a, 211b by using the single end, but also connected at both ends to the upper joint members 211a, 211b. Meanwhile, the position of the upper joint members is not limited to be only on the lower edge or the right edge. Moreover, the sorted order of the upper sensor members can be changed to the X-axially symmetrical arrays and the dot arrays disposed along the X-axially symmetrical arrays, while the conductive bridges 231 are connected along the Y-axis direction such that the dot arrays form arrays the symmetrical to Y-axis.

When the capacitance reaction signals are generated, the capacitance signals of the arrays 212a symmetrical to Y-axis of the upper sensor members are measured while the X-axially symmetrical arrays 212b of the upper sensor members are not electrically coupled. The results are used as the measuring data for generating the X component. Similarly, the capacitance signals of the arrays 212b symmetrical to X-axis of the upper sensor members are measured while the Y-axially symmetrical arrays 212a of the upper sensor members are not electrically coupled. The results are used as the measuring data for generating the Y component.

Since the capacitance reaction signals are arrayed, which serve as reference data when determining the position by consecutive resistance responding signals. Accordingly, the process of determining the position of the touch point A1 according to the resistance responding signals is shortened, the responsiveness of the present invention of pressing and touch is enhanced, and the performance of writing function and plotting capability with the touch pad of the present invention is significantly improved.

In short, the goals and effects of the present invention can be achieved by the above described description of embodiments and structures, and the present invention is not seen in any other publications and products in real application, also it falls within the key requirements of utility model patent. We hereby apply for being granted to with the patent based on relative laws, and looking forward to being approved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch pad for multiple sensing, which is configured to receive touch and pressed-pressure made from at least one finger, conductor or object, comprising:
an upper conductive layer having a plurality of upper sensor members disposed on middle of one surface of said upper conductive layer and a plurality of upper joint members disposed on border of one surface of said upper conductive layer;
a lower conductive layer having a plurality of lower sensor members disposed on middle of one surface of said lower conductive layer and a plurality of lower joint members disposed on border of one surface of said lower conductive layer, which said lower sensor members are disposed against said upper sensor members in a certain distance; and
wherein said upper joint members are electrically coupled to said upper sensor members, said lower joint members are electrically coupled to said lower sensor members, distance-related capacitance on said plurality of upper sensor members and said plurality of lower sensor members for approaching fingers or conductors can be detected through said upper joint members and said lower joint members respectively, an overlapped portion of said upper sensor members and said lower sensor members are electrically conducted by said pressed-pressure, and at least one electrical signal can be generated from voltage difference between said upper joint members or between said lower joint members, which the strength of electrical signal is related to a distance of said pressed-pressure from said upper joint members or said lower joint members.

2. The touch pad for multiple sensing of claim 1, wherein said upper conductive layer further comprises an insulating sheet disposed at which side of said upper sensor members said lower sensor members do not face to in order to receive said finger or conductor touch, wherein said insulating sheet is flexible to allow local deformation of said upper conductive layer by said pressed-pressure.

3. The touch pad for multiple sensing of claim 1, wherein said lower conductive layer further comprises a substrate disposed at which side of said lower sensor members said upper sensor members do not face to in order to support said lower conductive layer.

4. The touch pad for multiple sensing of claim 1, wherein a plurality of spacers having three dimensional structure are disposed between said upper conductive layer and said lower conductive layer for isolating said plurality of upper sensor members and said plurality of lower sensor members from being electrical contacted without said pressed-pressure.

5. The touch pad for multiple sensing of claim 4, wherein said plurality of spacers are movable between said upper conductive layer and said lower conductive layer.

6. The touch pad for multiple sensing of claim 4, wherein at least three of said plurality of spacers are fixed between said upper conductive layer and said lower conductive layer.

7. The touch pad for multiple sensing of claim 1, wherein said layers are made with light-transmitted materials and applicable to a touch panel.

8. The touch pad for multiple sensing of claim 1, wherein at least one of said upper sensor members extends the ends to the border for forming electrical contacts with one of said upper joint members respectively.

9. The touch pad for multiple sensing of claim 1, wherein at least one of said lower sensor members extends the ends to the border for forming electrical contacts with one of said lower joint members respectively.

10. The touch pad for multiple sensing of claim 1, wherein said upper sensor members and said lower sensor members are completely overlapped in a certain region at least.

11. The touch pad for multiple sensing of claim 1, wherein distribution of said upper sensor members has a first axis symmetry, distribution of said lower sensor members has a second axis symmetry, and said first axis is not parallel to said second axis.

12. The touch pad for multiple sensing of claim 11, wherein said first axis is vertical against said second axis.

13. The touch pad for multiple sensing of claim 1, wherein said certain distance is related to area size, thickness and material structure of said upper sensor members and said lower sensor members and also related to dielectric of the space between said upper conductive layer and said lower conductive layer.

14. A touch pad for multiple sensing, which is configured to receive touch and pressed-pressure made from at least one finger, conductor or object, comprising:
an upper conductive layer having a plurality of upper sensor members disposed on middle of one surface of said upper conductive layer and a plurality of upper joint members disposed on border of one surface of said upper conductive layer;
a conducting layer having a plurality of conducting bridges which each of said conducting bridges has a span between any two of said upper sensor members to enable said two of upper sensor members being electrically conducted;
a lower conductive layer having a conducting film disposed on middle of one surface of said lower conductive layer and a plurality of lower joint members disposed on border of one surface of said lower conductive layer, which said conducting film is disposed against said upper sensor members and said conducting bridges in a certain distance; and
wherein said upper joint members are electrically coupled to said upper sensor members, distance-related capacitance on said plurality of upper sensor members for approaching fingers or conductors can be detected through said upper joint members, an overlapped portion of said upper sensor members and said conducting bridges and said conducting film is electrically conducted by said pressed-pressure, and at least one electrical signal is generated from voltage difference between said upper joint members or between said lower joint members, which the strength of electrical signal is related to a distance of said pressed-pressure from said upper joint members or said lower joint members.

15. The touch pad for multiple sensing of claim 14, wherein said upper conductive layer further comprises an insulating sheet disposed at which side of said upper sensor members said conducting film does not face to in order to receive said finger or conductor touch, and said insulating sheet is flexible to allow local deformation of said upper conductive layer by said pressed-pressure.

16. The touch pad for multiple sensing of claim 14, wherein said lower conductive layer further comprises a substrate disposed at which side of conducting film said upper sensor members do not face to in order to support said lower conductive layer.

17. The touch pad for multiple sensing of claim 14, wherein a plurality of spacers having three dimensional structure are disposed between said upper conductive layer and said lower conductive layer for isolating said plurality of upper sensor members and said conducting film from being electrical contacted without said pressed-pressure.

18. The touch pad for multiple sensing of claim 17, wherein said plurality of spacers are movable between said upper conductive layer and said lower conductive layer.

19. The touch pad for multiple sensing of claim 17, wherein at least three of said plurality of spacers are fixed between said upper conductive layer and said lower conductive layer.

20. The touch pad for multiple sensing of claim 14, wherein said layers are made with light-transmitted materials and applicable to a touch panel.

21. The touch pad for multiple sensing of claim 14, wherein said certain distance is related to flexibility of said upper conductive layer.

22. The touch pad for multiple sensing of claim 14, wherein said lower conductive layer has at least two lower joint members on two sides of said surface electrically coupled to said conductive film respectively.

23. The touch pad for multiple sensing of claim 14, wherein said lower conductive layer has at least four lower joint members on four sides of said surface and electrically coupled to said conductive film respectively.
